(19) United States
(12) Patent Application Publication
(10) Pub. No.: US 2016/0203638 A1
(43) Pub. Date: Jul. 14, 2016

(54) METHOD FOR DISPLAYING SECTION VIEWS OF A 3D MODEL USING A FRAGMENT SHADER

(71) Applicant: SCULPTEO, Villejuif (FR)

(72) Inventors: Vivien CHAPPELIER, SAINT-AUBIN D'AUBIGNE (FR); Clement MOREAU, CLAMART (FR)

(21) Appl. No.: 14/914,525

(22) PCT Filed: Aug. 26, 2013
(86) PCT No.: PCT/IB2013/002098

§ 371 Date: Feb. 25, 2016

(51) Int. Cl. G06T 17/20

(52) U.S. Cl. CPC G06T 17/20

(57) ABSTRACT

A method for interactively displaying section views of a 3D model (10), includes the following steps:
Performing a projection of the 3D model (10);
Using a table (20) having two dimensions including components of the projected 3D model (10), determining if each entry in the table (20) is modified or not by comparing the 3D coordinates of a point (30) corresponding to the entry before projection with an oriented section surface (40) and by defining if the point (30) is in front of or behind the oriented section surface (40); and
Drawing the point (30) if the point (30) is behind the oriented section surface (40).

### FIELD OF THE INVENTION

The present invention pertains to the field of calculation and presentation of 3D models.

The present invention more particularly relates to a method for displaying section views of a 3D model using a fragment shader.

### BACKGROUND OF THE INVENTION

The presentation of section views of a 3D model allows visualizing and representing the inside of the 3D model, contrary to the classical views that only present the outside.

In the frame of computer-aided design or CAD, it allows validating the mechanical solidity, the inside clearance, and generally the mechanical operation of modelled pieces.

Applied to 3D printing, it allows the user to verify the compliance of his model in a set before execution.

The effective calculation of a sectioned 3D model, using the intersection of its components with a section surface, can represent a prohibitive cost for an interactive use, depending on the complexity of the 3D model.

Therefore, there is a need for presenting section views of a 3D model at display time in an interactive way, without explicitly calculating the 3D representation. Furthermore, in the frame of 3D printing, the presentation of these views in a browser at order time makes the validation easier, and avoids installing an application on the computer of the final user or of the designer.

Partial solutions to the above-mentioned problem exist:
A) The explicit calculation of a 3D model using the intersection of the components of the model and the components of the section surface.
   The calculation cost depends on the complexity of a 3D model and necessitates performing the calculation in the browser in the frame of an online application, or to download a new 3D model. In the first case, the efficiency of the calculations is very limited. In the second case, the download of a sectioned 3D model involves a further latency. In both cases, the interactivity is reduced to a use of models having a low complexity.
B) The implicit calculation of the section at display time using ray tracing, by calculation of Boolean operations on ray segments.
   The complexity of this technique depends on the complexity of the model and on the image resolution. This technique is also too costly in terms of calculation for an interactive use in a browser, although it can be applied to models having a low complexity or having low picture resolution.
C) The implicit calculation of one or several sections by a plane during the display by a 3D acceleration card, through intersection of edges of triangles constituting the 3D model before effective drawing. In particular, this can be performed using the glClipPlane feature of the OpenGL standard that is available on numerous 3D acceleration cards.

### SUMMARY OF THE INVENTION

The present invention aims at solving the above-mentioned drawbacks of the prior art solutions.

The present invention is defined, in its broadest sense, as a method for interactively displaying section views of a 3D model, characterized in that it comprises the following steps:
Performing a projection of said 3D model;
Using a table having two dimensions comprising components of said projected 3D model, determining if each entry in said table is modified or not by comparing the 3D coordinates of a point corresponding to the entry before projection with an oriented section surface and by defining if said point is in front of or behind said oriented section surface; and
Drawing said point if said point is behind said oriented section surface.

Therefore, the method according to the present invention allows interactively presenting section views of a 3D model without modifying the 3D model itself.

Preferably, said method is performed using Internet and a browser program.

According to an embodiment, said method allows the online presentation of section views.

Advantageously, said comparison is performed using a computer program.

According to an embodiment, said 3D model is constituted of triangles forming a mesh.

Preferably, said 3D model is displayed using a 3D acceleration card and said determination is performed using a fragment shader of said 3D acceleration card.

According to an embodiment, an interruption of the drawing of a fragment is performed using an instruction provided by a programming language of said 3D acceleration card.

According to an embodiment, said section surface is a plane defined by the following equation: a*x+b*y+c*z+d=0 and in that said determination is performed by a scalar product of the vector (a,b,c,d) and the vector (x,y,z,1) then comparing to zero; x, y and z being the 3D coordinates before projection of the point to be drawn.

According to another embodiment, said section surface is an axis-aligned plane and in that said determination is performed by comparing one of coordinates x, y or z with the distance of the section surface to the origin; x, y and z being the 3D coordinates before projection of the point to be drawn.

According to an embodiment, said method uses WebGL technology and a GLSL program.

According to an embodiment, said method uses Flash technology and an AGAL program.

According to an embodiment, said method uses a mobile application and a GLSL program.

### BRIEF DESCRIPTION OF THE DRAWINGS

The following detailed description will be better understood with the drawings, in which:

FIG. 1 illustrates the different steps of the method according to the present invention; and

FIG. 2 represents the method according to the invention in an embodiment.

### DETAILED DESCRIPTION OF THE EMBODIMENTS OF THE INVENTION

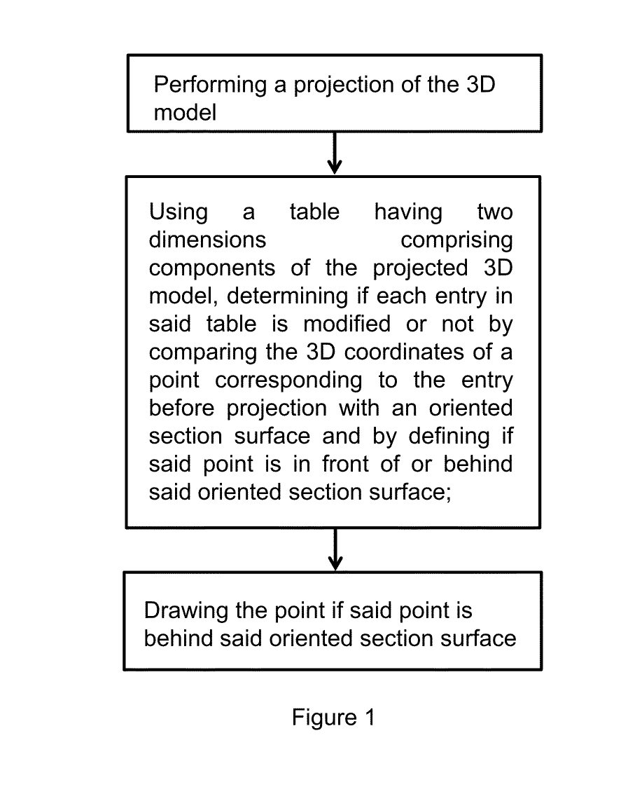

FIG. 1 illustrates the different steps of the method according to the present invention.

The present invention relates to a method for interactively displaying section views of a 3D model 10, comprising the following steps:
Performing a projection of said 3D model 10;
Using a table 20 having two dimensions comprising components of said projected 3D model 10, determining if each entry in said table 20 is modified or not by comparing the 3D coordinates of a point 30 corresponding to the entry before projection with an oriented section surface 40 and by defining if said point 30 is in front of or behind said oriented section surface 40; and
Drawing said point 30 if said point 30 is behind said oriented section surface 40.

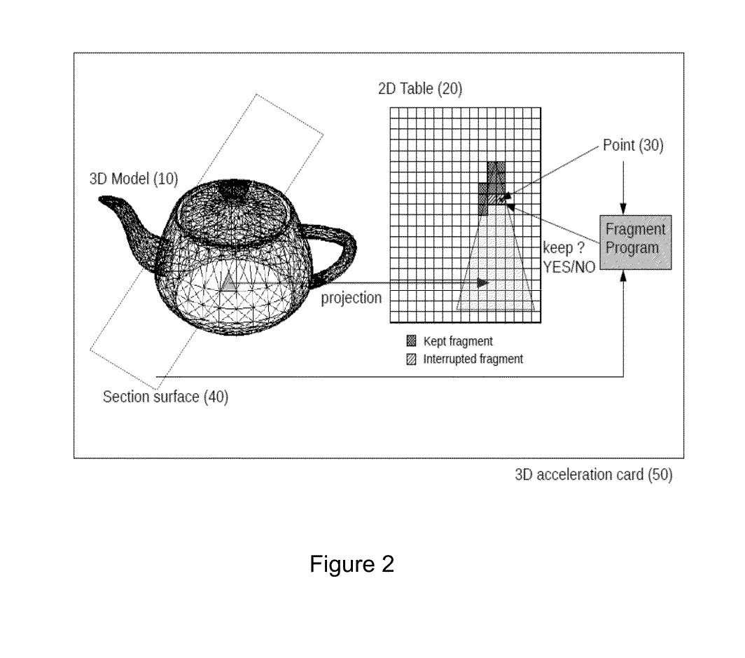

FIG. 2 represents the method according to the invention in an embodiment.

The 3D model 10 is represented on FIG. 2.

As shown on FIG. 2, a projection for each element of the 3D model 10 is performed, and a 2D table 20 is used.

Using the 2D table 20 shown on FIG. 2, the method according to the present invention comprises a step of determining if each entry in the table 20 is modified or not by comparing the 3D coordinates of a point 30 corresponding to the entry before projection with an oriented section surface 40 and by defining if the point 30 is in front of or behind the oriented section surface 40.

These steps are repeated for each triangle and then for each fragment of each triangle.

According to the present invention, sections are calculated at display time by a 3D acceleration card, in prematurely interrupting the drawing of fragments of the 3D model 10 in a program called “fragment shader”. The method according to the present invention relies on technologies present in most browsers that are deployed today. Therefore, the present invention can easily be deployed online.

The decision that is made is programmable and is not limited to section planes. It allows the section by any surface that can be described by an equation or by a program.

In an embodiment, the method is performed using Internet and a browser program, and it allows the online presentation of section views.

The comparison can be performed using a computer program.

In an embodiment, said 3D model 10 is constituted of triangles 11, 12, 13 forming a mesh.

In an embodiment, the 3D model 10 is displayed using a 3D acceleration card 50 and said determination is performed using a fragment shader of said 3D acceleration card 50.

In an embodiment, an interruption of the drawing of a fragment is performed using an instruction provided by a programming language of said 3D acceleration card 50.

FIG. 2 illustrates the decision to draw or not made by the fragment program.

In a particular embodiment, the section surface 40 is a plane defined by the following equation: a*x+b*y+c*z+d=0 and in that said determination is performed by a scalar product of the vector (a,b,c,d) and the vector (x,y,z,1) then comparing to zero; x, y and z being the 3D coordinates before projection of the point 30 to be drawn.

In another embodiment, the section surface 40 is an axis-aligned plane and in that said determination is performed by comparing one of coordinates x, y or z with the distance of the section surface 40 to the origin; x, y and z being the 3D coordinates before projection of the point 30 to be drawn.

The method according to the present invention can use WebGL technology and a GLSL program.

It can also use Flash technology and an AGAL program.

Finally, it can also use a mobile application and a GLSL program.

The above specification, examples and drawings provide a complete description of the method according to the present invention. Since many embodiments of the invention can be made without departing from the spirit and scope of the invention, the invention resides in the claims herein after appended.

1. Method for interactively displaying section views of a 3D model (10), which comprises the following steps:
Performing a projection of said 3D model (10);
Using a table (20) having two dimensions comprising components of said projected 3D model (10), determining if each entry in said table (20) is modified or not by comparing the 3D coordinates of a point (30) corresponding to the entry before projection with an oriented section surface (40) and by defining if said point (30) is in front of or behind said oriented section surface (40); and
Drawing said point (30) if said point (30) is behind said oriented section surface (40).

2. Method according to claim 1, wherein the method is performed using Internet and a browser program.

3. Method according to claim 1, wherein the method allows the online presentation of section views.

4. Method according to claim 1, wherein said comparison is performed using a computer program.

5. Method according to claim 1, wherein said 3D model (10) is constituted of triangles (11, 12, 13) forming a mesh.

6. Method according to claim 1, wherein said 3D model (10) is displayed using a 3D acceleration card (50) and in that said determination is performed using a fragment shader of said 3D acceleration card (50).

7. Method according to claim 6, wherein an interruption of the drawing of a fragment is performed using an instruction provided by a programming language of said 3D acceleration card (50).

8. Method according to claim 1, wherein said section surface (40) is a plane defined by the following equation: a*x+b*y+c*z+d=0 and said determination is performed by a scalar product of the vector (a,b,c,d) and the vector (x,y,z,1) then comparing to zero; x, y and z being the 3D coordinates before projection of the point (30) to be drawn.

9. Method according to claim 1, wherein said section surface (40) is an axis-aligned plane and said determination is performed by comparing one of coordinates x, y or z with the distance of the section surface (40) to the origin; x, y and z being the 3D coordinates before projection of the point (30) to be drawn.

10. Method according to claim 1, wherein the method uses WebGL technology and a GLSL program.

11. Method according to claim 1, wherein the method uses Flash technology and an AGAL program.

12. Method according to claim 1, wherein the method uses a mobile application and a GLSL program.

13. Method according to claim 2 wherein said comparison is performed using a computer program.

14. Method according to claim 3 wherein said comparison is performed using a computer program.
